(19) United States
(12) Patent Application Publication
(10) Pub. No.: US 2006/0016794 A1
(43) Pub. Date: Jan. 26, 2006

(54) Strip-heating for building structures and infrastructures

(76) Inventor: Aldo Stabile, Crema (IT)

Correspondence Address: MALCOLM J ROMANO, 116 S CITRUS AVE, LOS ANGELES, CA, 90036, US

(21) Appl. No.: 10/530,909

(22) PCT Filed: Nov. 20, 2002
(86) PCT No.: PCT/IT02/00735

§ 371 Date: Apr. 8, 2005

(30) Foreign Application Priority Data
Oct. 10, 2002 (IT) MI2002A002146

(51) Int. Cl. H05B 3/00

(52) U.S. Cl. 219/213

(57) ABSTRACT

System for heating building constructions (100) and infrastructures characterized by there being placed in structures (100), especially in their walls and floor (107), one or more lengths (111-113), laid side by side, of a strip having a constant transversal section and two substantially equal cores of very high electrical conductivity, superimposed with an insulating film between them, coated with layers of insulating material, by the first ends of said cores (25, 26) being respectively connected to the cables (96, 97) of a source of electric current, and by the second ends of said cores, freed of the layers of insulating material, being tightly bent over to close the electric circuit.

The invention concerns a heating system for building structures and infrastructures.

The many processes and means available for surface and environmental heating in the above structures are essentially based on combustion especially using gas or electricity.

In the case of gas the system most widely used consists of a central boiler supplying radiators in the different rooms of a building.

In the second case current, circulating in electric resistances, is transformed into thermal energy.

These resistances reach very high temperatures, even of 1000° C.; heat is distributed by radiancy and by the convective motion of air.

In all cases much heat is lost along the thermal chain on account of the considerable thermal head between flame or electric resistance temperatures and ambient temperature, and especially due to lack of any real possibility of integrating the physico-mechanical structures of heating systems with the building structures to be heated, or of creating such structures which themselves can generate heat.

It follows that the energy utilised compared with that actually consumed is very low.

The present invention solves or at least greatly reduces these problems as will be explained here below.

Subject of the invention is a heating system for building structures and infrastructures.

In the walls or floor of these structures, laid side by side are one or more lengths of a strip of insulating material of a constant transversal section, in which two substantially equal cores of very high electrical conductivity, are superimposed with an insulating film in between.

After removing the layers of insulation from the first and second ends of said cores, their first ends are respectively connected to the two leads of a source of electric current, while their second ends are reciprocally connected by being tightly and repeatedly folded over.

Removal of the layers of insulating material from the ends of the two cores is facilitated by first quickly cooling them with a very cold fluid. In one type of execution, the first end of the length of strip is given a trapezoidal form ending with a rectangular extension corresponding to the lesser base of the trapezoid.

Said rectangular extension, with the insulating layers cleaned off, is inserted between the metal jaws of a clamp, freely sliding on the crosswise supports of a frame of insulating material and held firm by screws.

In this way electrical connection is established between the metal cores of the piece of strip and the conductors leading to a source of electricity, respectively connected to said jaws.

The clamp is inserted in a feed box which contains a transformer for supplying current of a voltage not exceeding 40 V and therefore amply within the safety limits for any person.

To facilitate its connection to the layers of flooring above and below, the strip may contain holes even of a considerable diameter.

In one type of execution a length of strip is laid in the floor of a room in a square or rectangular spiral form.

The first end of the piece of strip is fitted into the clamp in the electric feed box placed against one wall.

In the spirally laid strip there are straight lengths bent at the corners to change direction in relation to that of the piece already laid, until the centre of the room is reached and the strip is cut off.

The electric circuit is closed by the cut end being tightly bent back on itself, and then that of the second end of the core after removal of the layers of insulating material.

In another type of execution the strip is laid on the floor of a room by cutting it into lengths laid side by side and electrically connecting, in parallel or in series, the first ends of the two metal cores of each piece to pairs of electric conductors these in turn being connected, by a pair of central wires, to the feed box.

The electric circuit is then closed as before by tightly bending back the second end of each piece and then of the second end of the cores from which the layers of insulating material have been removed.

Advantageously, the cores may be of aluminium or of copper.

Advantageously the insulating film between the two cores is of polyester.

The material of the strip may preferably be of bitumen or plastic material.

The bitumen may be associated to a plastomer or to an elastomer.

Advantageously the plastic material may consist of polyester.

The strip may be covered with protective fabric.

In one advantageous type of execution the strip transmits electric power between 100 and 300 W/m².

For laying purposes, connection between the strip and the layers on either side of it may be facilitated by the presence of holes, even of a considerable diameter, in the strip.

Strip dimensions are preferably as follows: overall thickness 2 mm, thickness of each metal core 0.2 mm, thickness of the layer of insulation between cores, 0.1 mm.

The invention offers evident advantages.

By placing the two metal cores one over the other, separated by a layer of insulation, electric feed can be applied to one end of the strip only by means of the clamp with two jaws respectively connected by the two conductors to the source of electric current.

This not only facilitates installation but drastically reduces manual labour.

Transformation of mains current down to a voltage not exceeding 40V eliminates any danger to users.

As the two conductors placed side by side through which equal and reverse current passes, creating two opposite electromagnetic fields that cancel each other out, the resulting electromagnetic field tends towards zero thus eliminating risks of atmospheric pollution.

The described system may be summed up as ensuring maximum simplicity of application, reducing to zero the electromagnetic field, together with diffusion of constant heat giving a high output from an extremely simple and easily operated installation.

Characteristics and purposes of the disclosure will be made still clearer by the following examples of its execution illustrated by diagrammatically drawn figures.

FIG. 1 A roll of strip with double metal core and insulating film between them, clad with layers of insulating material, subject of the invention, perspective view with cross section shown in detail.

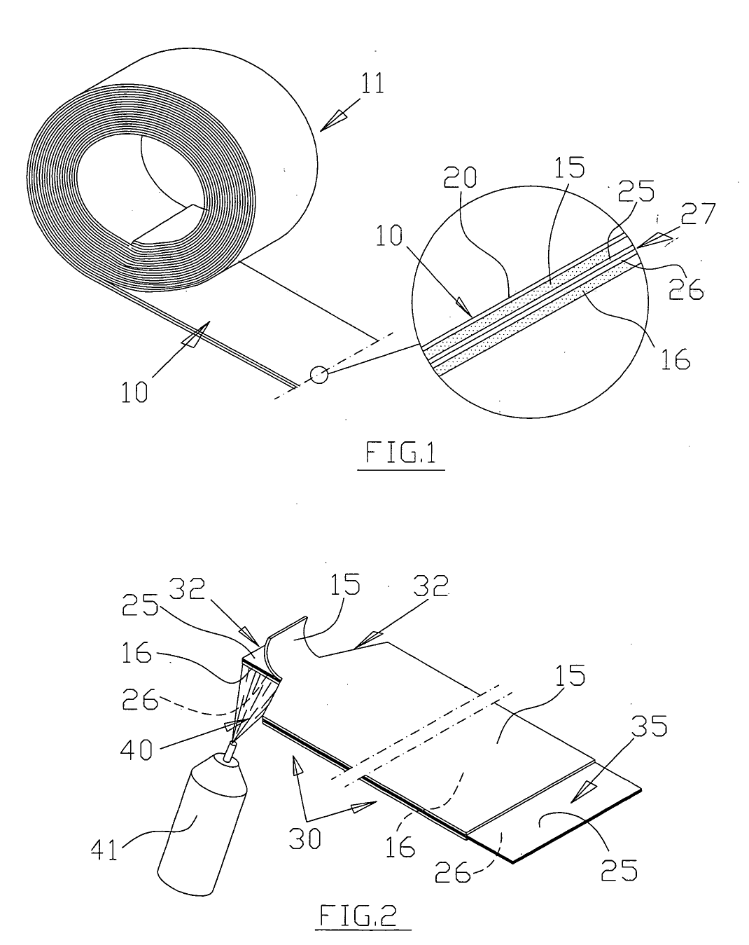

FIG. 2 A length of strip showing the first shaped end while rapid cooling of the insulating layers at both ends is in progress to detach them from the double metal core, showing one layer at the first end already detached and ready for cutting, and with both layers detached from the second end, perspective.

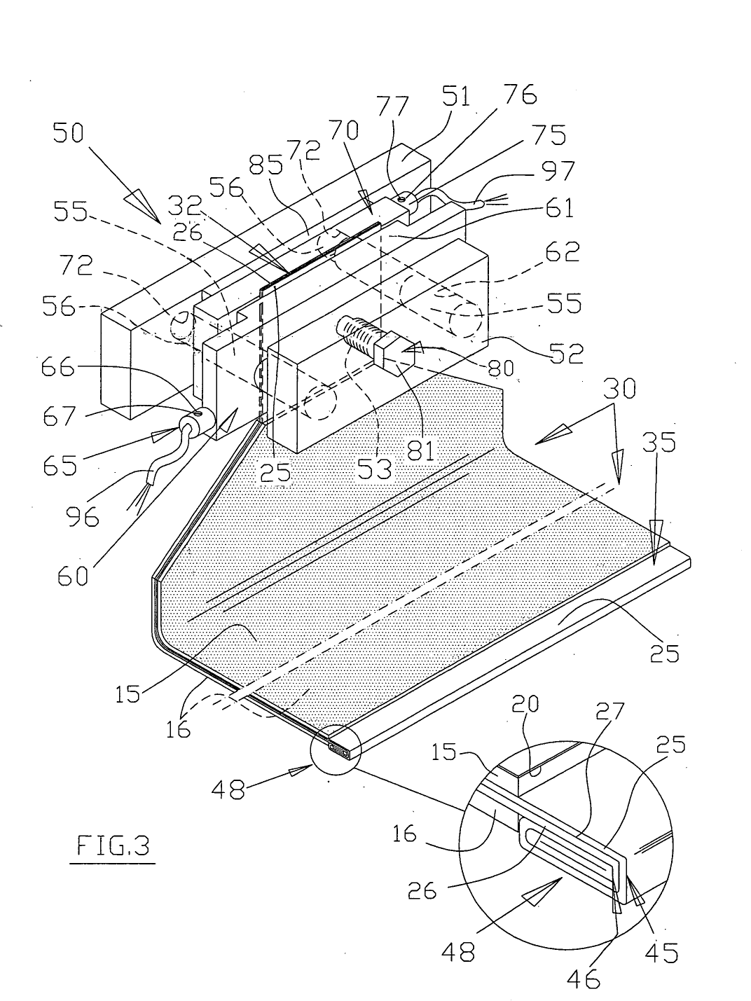

FIG. 3 A length of strip, the first end being inserted in a clamp for connection to the source of electric current and the second end closed in an electric circuit by repeated folds, perspective.

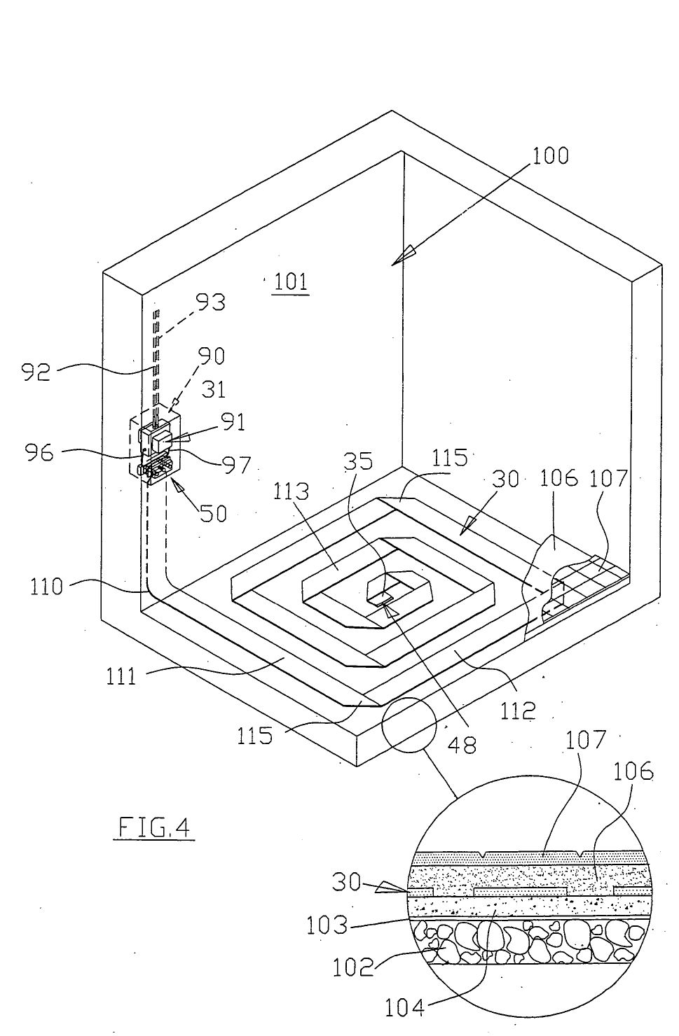

FIG. 4 A length of strip in the form of a square spiral, fitted in the floor of a room, connected to a feed box, perspective with cross section in detail.

FIG. 5 Installation of lengths of strip laid side by side in the floor of a room, perspective.

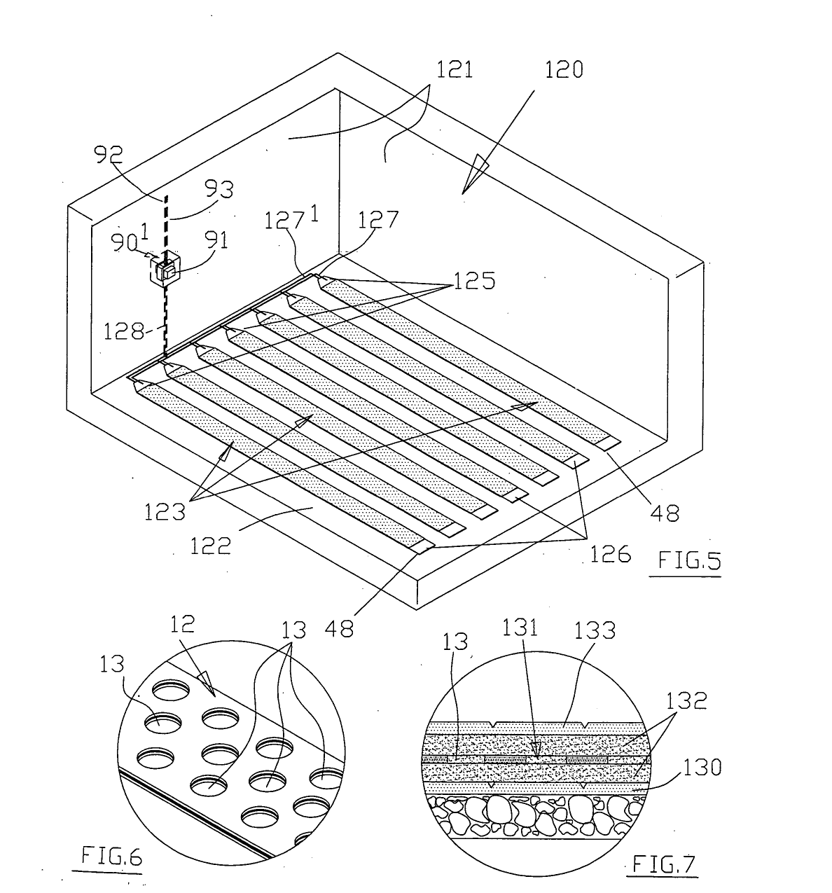

FIG. 6 A piece of strip with perforations, perspective.

FIG. 7 Enlarged cross section of a deteriorated floor where a length of perforated strip has been bonded to the glue for laying new tiles.

FIG. 1 shows a roll 11 of strip 10 with a pair of cores 25, 26 separated by a polyester film 27 and covered by layers 15, 16 of insulating material.

Layer 15 is covered with protective fabric 20.

FIG. 2 shows a length 30 of the strip 10 with one end 32 given a trapezoid shape and with a rectangular extension as wide as the lesser base, while said extension is being rapidly cooled by the fluid 40 sprayed on from the container 41 to facilitate detachment of the insulating layers 15 and 16 from the metal cores 25 and 26.

The layer 15 has been detached and is ready for cutting.

The metal cores 25, 26 can be seen on the end 35 having already been detached from the insulating layers 15, 16.

FIG. 3 illustrates the length 30 with extension of the end 32, and with the insulating layers 15, 16 cleaned off, inserted in a clamp 50 for connecting the metal cores 25, 26 to the source of electric current.

Said clamp comprises the base 51, head 52 and two supports 55, all of plastic material.

The first conductor jaw 60 with rearward extension 61 can freely slide through the holes 62 on the front of the supports 55.

The second conductor jaw 70 can freely slide through the holes 72 on the rear extension 56 of the supports.

At one end the conductor jaw 60 presents a clamp 65 with screw 67 for fixing an electric cable 96 inside the transversal hole 66.

At one end the second conductor jaw 70 presents a clamp 75 with screw 77 for fixing an electric cable 97 inside the transversal hole 76. The conductor jaw 60 can be pressed up against conductor jaw 70 using the hexagonal head 81 to screw the threaded pin 80 into the threaded hole 53 in the head 52.

An elastic cushion 85 is placed between the conductor jaw 70 and the base plate 51.

Wires 96 and 97 connect the terminals 65 and 75 to the transformer 91 (see FIG. 4) inside the feed box 90, connected to the source of electric current by electric lines 92 and 93.

As the end 32 of the piece of strip 30 has been freed of insulating layers 15, 16, by tightening the conductor jaw 60 against the conductor jaw 70 using the threaded pin 80, electric current reaches the two cores 25 and 26 through the cables 96 and 97.

Repeated folding 45 and 46 of the end 35 of the piece of strip 30, also freed of the insulating layers 15 and 16, determines closure of the electric circuit in the second end of the two cores 25 and 26 which therefore act as electric resistances and generate heat.

FIG. 4 illustrates an indoor room 100 on whose floor the length 30 of the strip 10, shown in detail in FIG. 3, has been laid.

The parallelepiped feed box 90 has been mounted in the wall 101, said box containing the clamp 50 and above it a transformer 91 connected to the source of electric current by lines 92 and 93, output voltage from the transformer not exceeding 40 V.

The length of strip 30, bent vertically at 110, passes through the wall 101 and enters the feed box 90 through a slit in the bottom, so that its end 32 can be inserted between the jaws 60, 70 (FIG. 3) of the clamp 50 and the two first ends of the two cores 25 and 26 be connected to the source of electric current.

A polythene film 103 is placed on the ground 102 and over this a layer of polystyrene 104.

On this layer 104 the length 30 of strip 10 is laid in the form of a spiral, winding towards the centre of the room with lengths placed at 90°, like 111, 112, 113, and with turns made at each angle 115 to change direction in relation to the length just previously laid.

The second end of the cores 25, 26 makes contact, the electric circuit being then closed by the end 35 of the length 30 which is bent over repeatedly to form a block 48 as shown in FIG. 3.

A layer of cement 106 is laid over the length of spirally laid strip 30 and on top of this the flooring surface 107.

FIG. 5 shows a different use made of the strip 10 in a long room 120 with walls 121.

The strip 10 is here cut into lengths 123 laid parallel side by side.

The first ends of the cores 25, 26 are connected by wires 127, 127¹ and by the central conductor 128 to the feed box 90 this in turn being connected through the transformer 91 to electric lines 92, 93.

The second end 126 of said lengths 123 and therefore of cores 25, 26 makes contact and closes the electric circuit when folded up to form the block 48 as described in FIG. 3.

FIG. 6 shows a strip with perforations 13 of a diameter even up to 10 cm.

These holes assist bonding to layers in either side of the strip, as shown by the example in FIG. 7.

On the deteriorated floor 130 a length 131 of strip with holes 13 is laid and over it a new floor surface of tiles 133 fixed with glue 132 that penetrates the perforations and keeps the whole stable.

1. System for heating building structures (100, 120) and infrastructures,
characterized by there being placed in structures (100, 120), especially in their walls and floor (107, 122, 133), in lengths (111-113, 123, 131) laid side by side, one (30) or more lengths (123, 131) of a strip (10, 12), having a constant transversal section and comprising substantially equal cores (25, 26) of very high electrical conductivity, superimposed with an insulating film (27) between them, coated with layers of insulating material (15, 16), by the first ends of said cores (25, 26) being connected respectively by conductors (96, 97, 127, 128) to a source of electric current, and by the electric circuit being closed where the second end of said cores (25, 26), freed of its layers of insulating material (15, 16), is tightly folded (45, 46) back on itself.

2. System as in claim 1,
characterized in that the first and second ends of the two superimposed cores (25, 26) are rapidly cleaned of the layers (15, 16) of insulating material, with preliminary detachment of said layers (15, 16), by application of a fluid (40) at a very low temperature.

3. System as in claims 1 and 2,
characterized in that the first end (32) of the length (30) of strip (10, 12) is shaped as a trapezoid terminating in a rectangular extension, the width of which is equal to the lesser base of the trapezoid, which extension, when the layers (15, 16) of insulating material have been cleaned off, is inserted between the metal jaws (60, 70), freely sliding on crosswise supports (55, 56) of a frame (51, 52), of insulating material, of a clamp (50) comprising a screw-operated means of pressure (80,81) that determines electrial connection between the metal cores (15, 16) of said length (30) and the cables (96, 97) of a source of electric current, respectively connected to said jaws (60, 70).

4. System as in claim 3,
characterized in that the clamp (50) is placed inside a feed box (90).

5. System as in claims 3 and 4,
characterized in that a transformer (91) is placed in the feed box (90) said transformer being connected to the lines (92, 93) of a source of electric current and supplying the jaws (60, 70) of the clamp (50) with power not exceeding 40 V and therefore amply within the safety limit for any user.

6. System as in claim 1,
characterized in that the strip (12), to facilitate adherence to the layers, above and below, of flooring in which it is laid, presents perforations passing through.

7. System as in claims 1 to 6,
characterized in that a piece (30) of the strip (10, 12) is laid in the floor of a room (100), the rectangular extension of its first end (32), inserted inside the clamp (50) in the electric feed box (90) mounted on a wall (101), said piece being laid in a spiral with straight lengths (111-113) and with turns made at each end forming an angle (115) to change direction in relation to the length just previously laid, until the centre of the room (100) is reached where the strip is cut off and the electric circuit is closed by tightly and repeatedly bending its second end (35), from which the layers (15, 16) of insulating material have been removed, and by reciprocal contact between the second ends of the cores (25, 26).

8. System as in claims 1 and 2,
characterized in that several lengths (123) of the strip (10, 12) are laid side by side in the floor of a room (120), the first ends of the two metal cores (25, 26) of each length (123) being electrically connected in parallel or in series, to pairs of electric wires (127, 127¹) these in turn being connected by a pair of conductors (128) to the transformer (91) in a feed box (90¹), connected to the lines (92, 93) of a source of electric current, the electric circuit being closed by the second end (126) of the lengths (123), from which the layers (15, 16) of insulating material have been removed, being tightly bent over and therefore by reciprocal contact between the second ends of the metal cores (25, 26).

9. System as in claim 1,
characterized that the cores (25, 26) are of aluminium.

10. System as in claim 1,
characterized in that the cores (25, 26) are of copper.

11. System as in claim 1
characterized in that the insulating film (27) between the two cores (25, 26) is of polyester.

12. System as in claim 1,
characterized in that the material (15, 16) of the strip (10, 12) is bitumen.

13. System as in claim 11,
characterized in that the bitumen is associated to a plastomer.

14. System as in claim 11
characterized in that the bitumen is associated to an elastomer.

15. System as in claim 1,
characterized in that the material (15, 16) of the strip is plastic.

16. System as in claim 14,
characterized in that the plastic material is polyester.

17. System as in claim 1,
characterized in that the strip (10, 12) is coated with protective fabric (20).

18. System as in claim 16,
characterized in that the protective fabric is polyester.

19. System as in claim 16,
characterized in that the protective fabric is fibreglas.

20. System as in claim 1,
characterized in that the strip (10, 12) transmits electric power comprised between the values of 100-300 W /m².

21. System as in claim 1
characterized in that the best way of installing the strip (10, 12) in the ground (102) comprises, laid one after another, a film (103) of polythene, a layer of polystyrene (104), a length of strip (30), a layer of cement and the floor surfacing (107).

22. System as in claim 1,
characterized in that, to facilitate adherence among the layers on either side of it, the strip (12) presents perforations whose diameter may even be 10 cm, spaced apart also by 10 cm.

23. System as in claim 1,
characterized in that strip dimensions are substantially as follows: overall thickness 2 mm, thickness of each metal core: 0.2 mm, thickness of the insulating film between cores: 0.1 mm.
